(19) United States
(12) Patent Application Publication
(10) Pub. No.: US 2013/0235089 A1
(43) Pub. Date: Sep. 12, 2013

(54) 3-D Displaying Device And Method For Controlling Displaying

(71) Applicant: Chih-tsung Kang, Shenzhen (CN)

(72) Inventor: Chih-tsung Kang, Shenzhen (CN)

(73) Assignee: Shenzhen China Star Optoelectronics Technology Co. LTD., Shenzhen (CN)

(21) Appl. No.: 13/510,292

(22) PCT Filed: Mar. 16, 2012
(86) PCT No.: PCT/CN12/72416

§ 371 Date: May 16, 2012

(30) Foreign Application Priority Data
Mar. 8, 2012 (CN) 201210059412.3

(51) Int. Cl. G09G 5/10; G09G 3/36

(52) U.S. Cl. 345/690; 345/102

(57) ABSTRACT

The present invention provides a 3-D displaying device and a method for controlling the same. The liquid crystal displaying panel is configured with a plurality of displaying sections which are driven and scanned from sides to a center thereof. A plurality of backlight module is provided and also controlled with respect to the scanning sequence of the displaying device in a way that it opens from sides to center thereof. Each of the backlight units is turned on only when the corresponding displaying section receives a driving signal of a picture, and the pixels of the displaying section reacts, each of the backlight units is turned off only when the displaying sections receive another driving signal of a picture. With this arrangement, the duration of turn-on and running time of the backlight units is increased so as to reduce the crosstalk of the displaying device, and the ghosting image is reduced. The displaying effect is increased, and the substantial experience of the viewer is upgraded.

### FIELD OF THE INVENTION

The present invention relates to a technology of displaying device, and more particularly to a 3-D displaying device and a method for controlling the displaying.

### BACKGROUND OF THE INVENTION

In recent years, there is a great leap on the 3-D displaying technology, and it has become a hop spot of research. The 3-D displaying technology can be greatly implemented in the fields of the medical, commercial, military, exhibition, and game. In addition, it has become more and more important to these fields. Referring to FIG. 1, an existing 3-D displaying device is shown. This conventional 3-D displaying device includes a liquid crystal display 10, and a pair of shuttle glasses 13. The liquid crystal display 10 generally includes a liquid crystal display panel 11, and a backlight module 12. The liquid crystal display panel 11 can display a left-eye-picture and a right-eye-picture alternatively with the illumination from the backlight module 12.

The shuttle glasses include a left lens 131, and a right lens 132. Each of the left lens 131 and the right lens 132 is incorporated with two polarizers (not shown in this Figure), and a layer of liquid crystal (not shown) disposed therebetween. When the operating voltage is applied to the liquid crystal layer alternatively, the left lens 131 and the right lens 132 can be turned on and off respectively to the voltage applied thereto. During the displaying, when the display panel 11 projects a left-eye-picture, the left lens 131 is turned on, while the right lens 132 is turned off. As a result, the left-eye-picture is transmitted to the left eye of the viewer, while what the viewer sees through his right eye is black. Alternatively, when the liquid display panel 11 shows a right-eye-picture, then the left lens 131 is shut off, and the right lens 132 is turned on. Meanwhile, a right-eye-picture is transmitted to the right eye of the viewer, and what the left eye sees is black. By this arrangement, the left eye and right eye of the viewer receives a separated left-eye-picture and a right-eye-picture respectively, and our brain will configure those two pictures into a 3-D image.

Referring to FIG. 2, which is an operational clock or timing chart for the 3-D displaying device shown in FIG. 1. As shown in FIG. 2, the vertical axis represents the upper and lower positions of the liquid crystal display 11, and the horizontal axis represents time. Based on the existing technology, the backlight module 12 is divided into a plurality of horizontal sectors from top to bottom. Accordingly, the scanning sequences of the backlight module 12 starts from the top to bottom sequentially so as to control the on and off each horizontal sector. As shown in FIG. 1, the backlight module 12 is divided into S1, S2, S3, S4, and S5, totally five horizontal sectors. On the other hand, the liquid display panel 11 shows the left-eye-picture and the right-eye-picture alternatively. The timing for the left-eye-picture is T1, and the timing for the right-eye-picture is T2. T1 and T2 each represents a timing of a single frame. When the clock starts running, the signal or driving signal is sent to the liquid display panel 11 respect to those horizontal sectors from top to bottom. Once the pixel of the liquid crystal display is empowered by the driving voltage, it starts to react accordingly. As a result, because of the design of the pixel and the delay of the crystal, it takes a certain period of time, L0, to reach a stabilized condition. As the scanning sequence starts from S1, S2, S3, S4, and S5, and the turned off time of the left lens 131 is delayed, and the driving signal in horizontal sector S1 has been changed from the left-eye-picture into right-eye-picture. Because of the reacting time L0, it creates an issue as both the left-eye-picture and the right-eye-picture are co-existed in the horizontal sector S1. As a result, a ghosting image will be seen from sector S1. On the other hand, since the left lens 131 opens a little bit earlier, and it also supplies driving signal to horizontal sectors S1, S2, S3, S4, and S5. As mentioned above, there is a reacting time L0 on the pixels of the liquid crystal, those five sectors S1, S2, S3, S4 and S5 will be effected by the latest right-eye-picture more or less. As a result, a ghosting image will be seen.

Since the crosstalk between the left eye signal and the right eye signal, it creates a ghosting image. This ghosting image will surely affect the 3-D effect negatively.

Accordingly, there is a need to provide a novel 3-D displaying device, and a method for controlling.

### SUMMARY OF THE INVENTION

The main technical issue in which the present invention intends to address is to provide a 3-D displaying device and a method of controlling so as to reduce a so called ghosting image resulted from crosstalk so as to upgrade the 3-D displaying effects.

In order to resolve the technical issue mentioned above, the present invention provides a 3-D displaying device, comprises a liquid crystal displaying panel, alternatively displaying a left-eye-picture and a right-eye picture. The liquid crystal display is divided into a plurality of displaying sections starting from sides to a center thereof. The plurality of displaying sections is driven based on a scanning sequence starting from sides to the center. A plurality of backlight units each is arranged with respect to a corresponding displaying section. The duration of turn-on of each of the backlight units remaining same, and is turned on in a sequence such that each of the backlight units is turned on only when the corresponding displaying section receives a driving signal of a picture, and the pixels of the displaying section reacts, each of the backlight units is turned off only when the displaying sections receive another driving signal of a picture. Wherein the plurality of displaying sections includes a central displaying section, an outmost displaying section, and a transitional displaying section located between the central displaying section and the outmost displaying section, wherein a displaying of a picture is scanned by the sequence: scanning the outmost displaying section, then scanning the transitional section, and finally, scanning the central displaying section.

Wherein that the 3-D device includes a shuttle glasses configured with a left lens and a right lens turned on alternatively so as to transfer a left-eye-picture and a right-eye-picture alternatively.

In order to address the above-mentioned technical issues, according to another embodiment of the present invention, a 3-D displaying device is provided and characterized in that the 3-D device comprises a liquid crystal panel alternatively displaying a left-eye-picture and a right-eye-picture. The liquid crystal panel is divided into a plurality of displaying sections starting from sides to a center thereof; the plurality of displaying sections is driven according to a scanning sequence starting from the sides to the center thereof. A plurality of backlight units each is arranged to a corresponding displaying section. The plurality of units is turned on in sequence such that each of the backlight units is turned on only when the corresponding displaying sections receives a driving signal of a picture, and after corresponding pixels of a liquid crystal of the panel is responded, and is turned off only when the displaying section receives a driving signal of next picture.

Wherein the plurality of sections includes a central section, an outmost section, and a transitional section located therebetween. A picture is displayed with a scanning sequence starting from firstly driving the outmost section, and then driving the transitional section, and finally driving the central section.

Wherein the plurality of backlight units have identical duration of turn-on and running time.

Wherein the displaying device includes a shuttle glasses configured with a left lens and a right lens turned on alternatively so as to transfer a left-eye-picture and a right-eye-picture alternatively.

Wherein the left lens is turned on starting from the pixels of the firstly scanned displaying section of the liquid crystal displaying panel receives a driving signal for displaying a left-eye-picture, and reaches to a stabilized condition, and is turned off when the pixels of the lastly scanned displaying section of the display starts to receiving a driving signal of the right-eye-picture; and the right lens is turned on starting from the pixels of the firstly scanned displaying section of the liquid crystal displaying panel receives a driving signal for displaying a right-eye-picture, and reaches to a stabilized condition, and is turned off when the pixels of the lastly scanned displaying section of the display starts to receiving a driving signal of the left-eye-picture.

In order to resolve the technical issue mentioned above, a method for controlling 3-D displaying device is provided and characterized in that the steps includes a step of controlling the liquid crystal displaying panel to display a left-eye-picture and a right-eye-picture alternatively. Wherein the liquid crystal displaying panel is divided into a plurality of displaying sections starting from sides to a center thereof, the plurality of displaying sections being driven according to a scanning sequence starting from the sides to the center thereof. A step of providing a plurality of backlight units is provided and each is arranged to a corresponding displaying section. The plurality of units are turned on in sequence such that each of the backlight units is turned on only when the corresponding displaying sections receives a driving signal of a picture, and after corresponding pixels of a liquid crystal of the panel is responded, and is turned off only when the displaying section receives a driving signal of next picture.

Wherein the plurality of sections includes a central section, an outmost section, and a transitional section located therebetween, a picture being displayed with a scanning sequence starting from firstly driving the outmost section, and then driving the transitional section, and finally driving the central section.

Wherein the duration of turn-on and running time of each of the plurality of backlight units remains the same.

Wherein the method of controlling further comprises the step of controlling the duration of turn-on of the left lens and right lens alternatively so as to transfer a left-eye-picture and a right-eye-picture alternatively.

Wherein the left lens is turned on starting from the pixels of the firstly scanned displaying section of the liquid crystal displaying panel receives a driving signal for displaying a left-eye-picture, and reaches to a stabilized condition, and is turned off when the pixels of the lastly scanned displaying section of the display starts to receiving a driving signal of the right-eye-picture; and the right lens is turned on starting from the pixels of the firstly scanned displaying section of the liquid crystal displaying panel receives a driving signal for displaying a right-eye-picture, and reaches to a stabilized condition, and is turned off when the pixels of the lastly scanned displaying section of the display starts to receiving a driving signal of the left-eye-picture.

The following advantages of the present invention can be achieved. As compared with the existing technology, in a 3-D displaying device and a method for controlling provided by the present invention, the liquid crystal displaying panel is configured with a plurality of displaying sections which are driven and scanned from sides to a center thereof. A plurality of backlight module is provided and also controlled with respect to the scanning sequence of the displaying device in a way that it opens from sides to center thereof. Each of the backlight units is turned on only when the corresponding displaying section receives a driving signal of a picture, and the pixels of the displaying section reacts, each of the backlight units is turned off only when the displaying sections receive another driving signal of a picture. With this arrangement, the duration of turn-on and running time of the backlight units is increased so as to reduce the crosstalk of the displaying device, and the ghosting image is reduced. The displaying effect is increased, and the substantial experience of the viewer is upgraded.

### BRIEF DESCRIPTION OF DRAWINGS

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings. Wherein

FIG. 1 is an illustrated perspective view of a prior art 3-D displaying device;

FIG. 2 is an operational timing chart of the 3-D displaying device made in accordance with the present invention;

FIG. 3 is another preferred embodiment of a 3-D displaying device made in accordance with the present invention;

FIG. 4 is an operational timing chart of the 3-D displaying device illustrated in FIG. 3; and

FIG. 5 is a flow chart of a controlling method of the 3-D displaying device made according to the present invention.

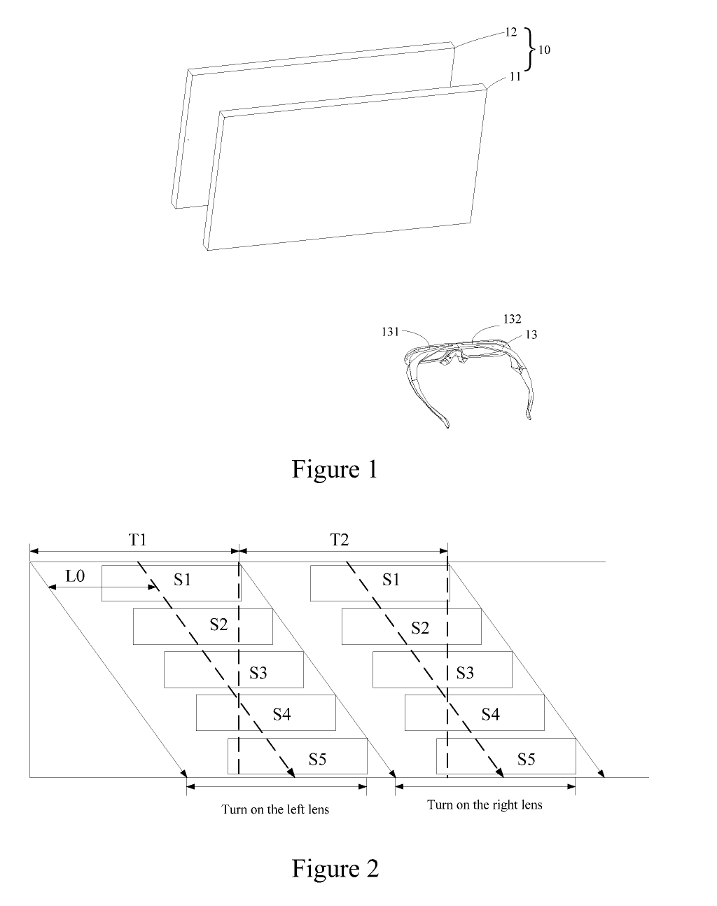

### DETAILED DESCRIPTION OF PREFERRED EMBODIMENTS

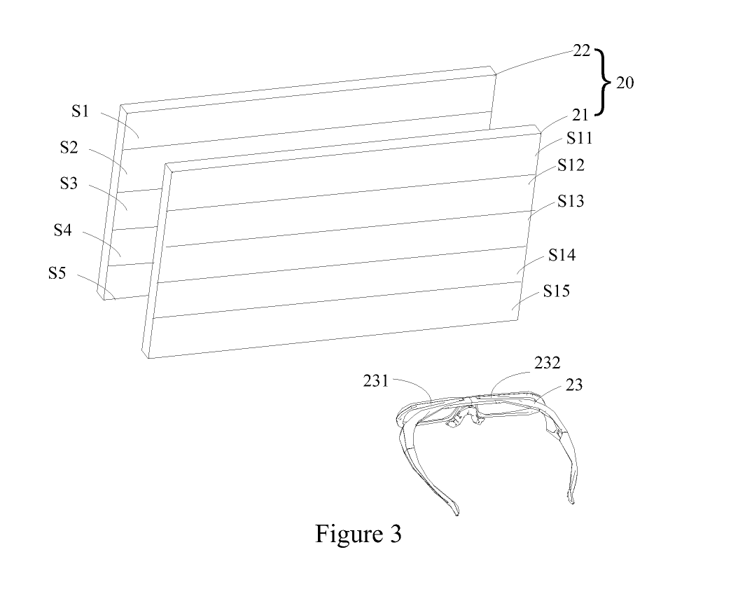

Referring to FIG. 3 in which a preferred embodiment of a 3-D displaying device made in according to the present invention is shown. As shown, the 3-D displaying device in accordance to the present invention includes a liquid crystal display 20, and a shuttle glasses 23. The liquid crystal display 20 further includes a liquid crystal displaying panel 21 and a backlight module 22. The liquid crystal displaying panel 21 is disposed between the backlight module 22 and the shuttle glasses 23, and is illuminated by the backlight module 22.

The liquid crystal displaying panel 21 illustrates a left-eye-picture and a right-eye-picture alternatively. The display panel 21 is divided into a plurality of displaying sections starting from sides to a center thereof. According to the present invention, the liquid crystal displaying panel 21 is divided into totally five (5) sections S11, S12, S13, S14, and S15. Displaying sections S11 and S15 are located at outmost area of the liquid crystal displaying panel 21, while displaying section S13 is located at a center of the liquid crystal displaying panel 21, and displaying sections S12 and S14 are located therebetween. It can also be referred to as transitional displaying sections.

The scanning method of the liquid crystal displaying panel 21 starts from the outmost sections, and then to the center sequentially so as to drive the displaying sections S11, S12, S13, S14 and S15. Accordingly, the displaying sections S11 and S15 are driven firstly, and then displaying sections S12 and S14 are driven, and finally, displaying section S13 is driven.

The backlight module 22 includes a plurality of backlight units corresponding to each of the displaying sections S11, S12, S13, S14 and S15 of the liquid crystal displaying panel 21. In the preferable embodiment, the backlight module 22 is configured by backlight units 51, S2, S3, S4 and S5, which are each assigned to align with a corresponding displaying sections S11, S12, S13, S14 and S15. The timing of turn-on of the backlight units S1, S2, S3, S4 and S5 is set to synchronized to the scanning sequence of the displaying sections S11, 512, 513, 514, and 515, i.e. the backlight units S1 and S15 are turned on firstly, then the backlight units S2 and S4 are turned, and finally, the central backlight unit S3 is turned on. This is to make sure that these backlight units S1-S5 are turned on only when the corresponding displaying sections S11-S15 receive a driving signal, and turned off only when the displaying sections S11-S15 start to receive another driving signal. On the other hand, the duration between turn-on and turn-off each of the backlight units are remained the same.

The shuttle glasses 23 includes a left lens 231 and a right lens 232, and which is synchronized with the liquid crystal displaying panel 21 by means of infra red signal, or blue tooth, or other communication. The left lens 231 and the right lens 232 can be turned on synchronically with respect to the liquid crystal displaying panel 21 so as to view the left-eye-picture and the right-eye-picture.

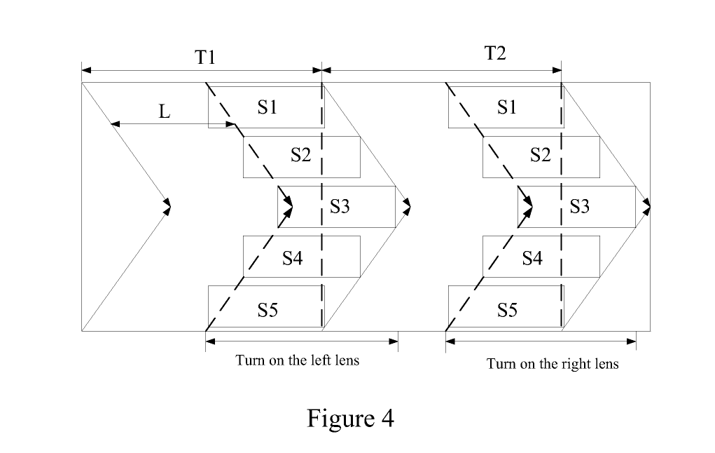

Referring to FIG. 4, which is a clock timing chart of the liquid crystal displaying panel shown in FIG. 3. As shown in FIG. 4, the liquid crystal displaying panel 41 displays the left-eye-picture and the right-eye-picture. T1 is the displaying duration of left-eye-picture, and T2 is the displaying duration of right-eye-picture. Each of the T1 and T2 represents the duration of the picture shown.

During the T1 of the left-eye-picture, the displaying sections S11 and S15 are driven firstly, and only when the displaying sections S11 and S15 response, the backlight units S1 and S5 are turned on. The backlight units S1 and S5 are turned off only when the displaying sections S11 and S15 start to receive the right-eye-picture. Afterword, the transitional displaying sections S12 and S14 are driven. The backlight units S2 and S4 are turned only when the displaying sections S12 and S14 response. The backlight units S2 and S4 are turned off only when the displaying sections S12 and S14 start to receive the right-eye-picture. Lastly, the central displaying section S13 is driven, and the backlight unit S3 is turned on only when the displaying section S3 responses. The backlight unit S3 is turned off only when the displaying section S13 starts to receive the right-eye-picture. The response time of the pixel of liquid crystal is L.

The turn-on time of the left lens 231 starts when the pixels of the firstly scanned displaying sections S11 and S15 of the liquid crystal displaying panel 21 receive the driving signal of the left-eye-picture, and reaches a stabled condition. The ending of the turn-on of the left lens 231 is when the pixels of the displaying sections S13 receive the driving signal of the right-eye-picture. The turn-on time of the right lens 232 starts when the pixels of the firstly scanned displaying sections S11 and S15 of the liquid crystal displaying panel 21 receive the driving signal of the right-eye-picture, and reaches a stabilized condition. The ending of the turn-on of the right lens 232 is when the pixels of the displaying sections S13 receive the driving signal of the left-eye-picture.

As compared to the technology of the existing 3-D displaying device, the scanning sequence of the liquid crystal liquid crystal displaying panel 21 of the present invention starts from the sides to center and then drives the displaying sections S11, S12, S13, S14, and S15 such that the scanning duration of the liquid crystal displaying panel 21 is reduced. Meanwhile, the duration of turn-on of the backlight units 51, S2, S3, S4 and S5 are increased. On the other hand, the backlight units 51, S2, S3, S4 and S5 are turned on only when the pixels of the liquid crystal response. This arrangement maximizes the duration of turn-on time of each of the backlight units S1, S2, S3, S4 and S5. With the advantages, the driving current of the 3-D displaying device in accordance with the present can be effectively reduced such that the cross-talk is lowered. With the reduced cross-talk, the ghosting image is also lowered. As a result, the present invention uses the lowest power to achieve the maximized quality improvement of the 3-D displaying device. The customer can readily have a brand new effect.

It should be noted that in the above description, the liquid crystal displaying device 21 and the backlight module 22 are both divided into five (5) different sections and units for illustration. However, it can be readily appreciated that the liquid crystal displaying panel 21 can be divided into even number, for example, it can be divided into six (6) sections, such as S21, S22, S23, S24, S25, and S26. Among those six sections, sections S21 and 26 are the outmost sections, sections S22 and S25 are transitional sections, and sections 23 and 24 are the central sections.

With the same principle, the backlight module 22 can be also divided into totally six (6) backlight units corresponding to those six (6) displaying sections S21, S22, S23, S24, S25 and S26. On the other hand, when the liquid crystal displaying panel 21 and the backlight module 22 are both divided into six (6) different sections and units, their scanning method and driving method are remained the same as that divided into five (5). As a result, no detailed description is given.

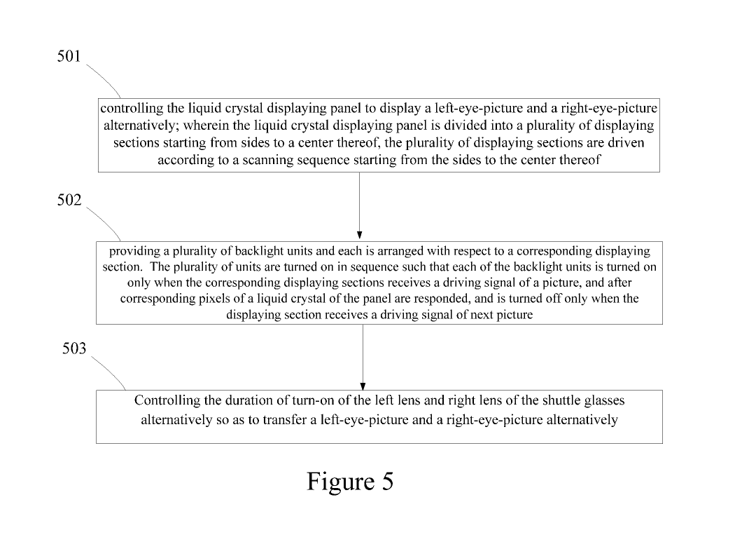

Referring to FIG. 5 which is a flow chart showing a controlling method of the 3-D displaying device made in accordance with the present invention. As shown in FIG. 5, the controlling method of the 3-D displaying device made in accordance with the present invention comprises the following steps.

Step 501: controlling the liquid crystal displaying panel 21 to display a left-eye-picture and a right-eye-picture alternatively; wherein the liquid crystal displaying panel is divided into a plurality of displaying sections starting from sides to a center thereof, the plurality of displaying sections are driven according to a scanning sequence starting from the sides to the center thereof.

Step 502: providing a plurality of backlight units and each is arranged with respect to a corresponding displaying section. The plurality of units are turned on in sequence such that each of the backlight units is turned on only when the corresponding displaying sections receives a driving signal of a picture, and after corresponding pixels of a liquid crystal of the panel are responded, and is turned off only when the displaying section receives a driving signal of next picture.

Step 503: Controlling the duration of turn-on of the left lens 231 and right lens 232 of the shuttle glasses 23 alternatively so as to transfer a left-eye-picture and a right-eye-picture alternatively.

Details of those above-described steps can be referred to the detailed description of preferred embodiments. As a result, no details will be given.

In conclusion, in a 3-D displaying device and a method for controlling provided by the present invention, the liquid crystal displaying panel is configured with a plurality of displaying sections which are driven and scanned from sides to a center thereof. As a result, it reduces the scanning time of the liquid crystal displaying device. In addition, each of the backlight units is turned on only when the corresponding displaying section receives a driving signal of a picture, and the pixels of the displaying section reacts, each of the backlight units is turned off only when the displaying sections receive another driving signal of a picture. With this arrangement, the duration of turn-on and running time of the backlight units is increased so as to reduce the crosstalk of the displaying device, and the ghosting image is reduced. The displaying effect is increased, and the substantial experience of the viewer is upgraded.

The description above is merely some preferable embodiments of the present invention, while is not intended to limit the implementation of the present invention. Any alternation and/or modifications based on the descriptions and drawings are to be construed as equivalent under the spirit of the present invention, and should be covered by the claims set forth below. On the other hand, even direct and indirect implementation of the present invention to other technology field, should still be covered by the claims as set forth below.

1. A 3-D displaying device, comprising:
a liquid crystal displaying panel, alternatively displaying a left-eye-picture and a right-eye picture, the liquid crystal display being divided into a plurality of displaying sections starting from sides to a center thereof, the plurality of displaying sections being driven based on a scanning sequence starting from sides to the center; and
a plurality of backlight units, each of the backlight units be arranged with respect to a corresponding displaying section, the duration of turn-on of each of the backlight units remaining same, and being turned on in a sequence such that each of the backlight units is turned on only when the corresponding displaying section receives a driving signal of a picture, and the pixels of the displaying section reacts, each of the backlight units is turned off only when the displaying sections receive another driving signal of a picture;
wherein the plurality of displaying sections includes a central displaying section, an outmost displaying section, and a transitional displaying section located between the central displaying section and the outmost displaying section, wherein a displaying of a picture is scanned by the sequence: scanning the outmost displaying section, then scanning the transitional section, and finally, scanning the central displaying section.

2. The 3-D displaying device as recited in claim 1, characterized in that the 3-D devices includes a shuttle glasses configured with a left lens and a right lens turned on alternatively so as to transfer a left-eye-picture and a right-eye-picture alternatively.

3. A 3-D displaying device, characterized in that the 3-D device comprises:
a liquid crystal panel alternatively displaying a left-eye-picture and a right-eye-picture, the liquid crystal panel being divided into a plurality of displaying sections starting from sides to a center thereof, the plurality of displaying sections being driven according to a scanning sequence starting from the sides to the center thereof; and
a plurality of backlight units each arranged to a corresponding displaying section, the plurality of units being turned on in sequence such that each of the backlight units is turned on only when the corresponding displaying sections receives a driving signal of a picture, and after corresponding pixels of a liquid crystal of the panel is responded, and is turned off only when the displaying section receives a driving signal of next picture.

4. The 3-D displaying device as recited in claim 3, characterized in that the plurality of sections includes a central section, an outmost section, and a transitional section located therebetween, a picture being displayed with a scanning sequence starting from firstly driving the outmost section, and then driving the transitional section, and finally driving the central section.

5. The 3-D displaying device as recited in claim 3, characterized in that the plurality of backlight units have identical duration of turn-on and running time.

6. The 3-D displaying device as recited in claim 3, characterized in that the displaying device includes a shuttle glasses configured with a left lens and a right lens turned on alternatively so as to transfer a left-eye-picture and a right-eye-picture alternatively.

7. The 3-D displaying device as recited in claim 6, characterized in that:
the left lens is turned on starting from the pixels of the firstly scanned displaying section of the liquid crystal displaying panel receives a driving signal for displaying a left-eye-picture, and reaches to a stabilized condition, and is turned off when the pixels of the lastly scanned displaying section of the display starts to receiving a driving signal of the right-eye-picture; and
the right lens is turned on starting from the pixels of the firstly scanned displaying section of the liquid crystal displaying panel receives a driving signal for displaying a right-eye-picture, and reaches to a stabilized condition, and is turned off when the pixels of the lastly scanned displaying section of the display starts to receiving a driving signal of the left-eye-picture.

8. A method for controlling 3-D displaying device, characterized in that the steps includes:
a step of controlling the liquid crystal displaying panel to display a left-eye-picture and a right-eye-picture alternatively;
wherein the liquid crystal displaying panel is divided into a plurality of displaying sections starting from sides to a center thereof, the plurality of displaying sections being driven according to a scanning sequence starting from the sides to the center thereof;
a step of providing a plurality of backlight units each arranged to a corresponding displaying section, the plurality of units being turned on in sequence such that each of the backlight units is turned on only when the corresponding displaying sections receives a driving signal of a picture, and after corresponding pixels of a liquid crystal of the panel are responded, and is turned off only when the displaying section receives a driving signal of next picture.

9. The method as recited in claim 9, characterized in that the plurality of sections includes a central section, an outmost section, and a transitional section located therebetween, a picture being displayed with a scanning sequence starting from firstly driving the outmost section, and then driving the transitional section, and finally driving the central section.

10. The method as recited in claim 8, wherein the duration of turn-on and running time of each of the plurality of backlight units remains the same.

11. The method as recited in claim 8, wherein the method of controlling further comprises the step of
controlling the duration of turn-on of the left lens and right lens alternatively so as to transfer a left-eye-picture and a right-eye-picture alternatively.

12. The method as recited in claim 11, characterized in that:
the left lens is turned on starting from the pixels of the firstly scanned displaying section of the liquid crystal displaying panel receives a driving signal for displaying a left-eye-picture, and reaches to a stabilized condition, and is turned off when the pixels of the lastly scanned displaying section of the display starts to receiving a driving signal of the right-eye-picture; and
the right lens is turned on starting from the pixels of the firstly scanned displaying section of the liquid crystal displaying panel receives a driving signal for displaying a right-eye-picture, and reaches to a stabilized condition, and is turned off when the pixels of the lastly scanned displaying section of the display starts to receiving a driving signal of the left-eye-picture.
